(19) United States
(12) Patent Application Publication
(10) Pub. No.: US 2009/0212041 A1
(43) Pub. Date: Aug. 27, 2009

(54) Heating Element

(76) Inventor: Werner Kahr, Deutschlandsberg (AT)

Correspondence Address: SLATER & MATSIL, L.L.P., 17950 PRESTON RD, SUITE 1000, DALLAS, TX, 75252-5793, US

(21) Appl. No.: 12/393,793

(22) Filed: Feb. 26, 2009

Related U.S. Application Data
(63) Continuation of application No. PCT/DE2007/001556, filed on Aug. 31, 2007.

(30) Foreign Application Priority Data
Sep. 1, 2006 (DE) 10 2006 041 054.8

(51) Int. Cl. H05B 3/14; H01C 17/00; H01C 17/28

(52) U.S. Cl. 219/553; 219/505; 29/611; 29/619

(57) ABSTRACT

A heating element with a ceramic body that has PTC properties is specified. The heating element has electrodes that are arranged on ceramic body. Both the ceramic body and the electrodes are lead-free.

This application is a continuation of co-pending International Application No. PCT/DE2007/001556, filed Aug. 31, 2007, which designated the United States and was not published in English, and which claims priority to German Application No. 10 2006 041 054.8 filed Sep. 1, 2006, both of which applications are incorporated herein by reference.

### BACKGROUND

Heating elements with ceramic PTC resistors are known, for example, from U.S. Pat. No. 4,899,032.

### SUMMARY

In one aspect, the invention specifies an environmentally friendly heating element.

A heating element with a ceramic body that has PTC properties is disclosed. (PTC stands for “positive temperature coefficient”). The heating element has electrodes that are arranged on the ceramic body. Both the ceramic body and the electrodes are lead-free.

With the preferred heating element it is possible to essentially avoid environmental stressors connected with disposal of heavy metals.

### BRIEF DESCRIPTION OF THE DRAWINGS

The heating element is explained by means of schematic, not-to-scale figures. In the figures:

FIG. 1 shows a heating element in cross section; and

FIG. 2 shows a heating element with multilayer electrodes, in cross section.

The following list of reference symbols can be used in conjunction with the drawings:
1 Body
2, 3 Electrodes
2a, 3a Inner contact layer
2b, 3b Diffusion barrier layer
2c, 3c Outer contact layer

### DETAILED DESCRIPTION

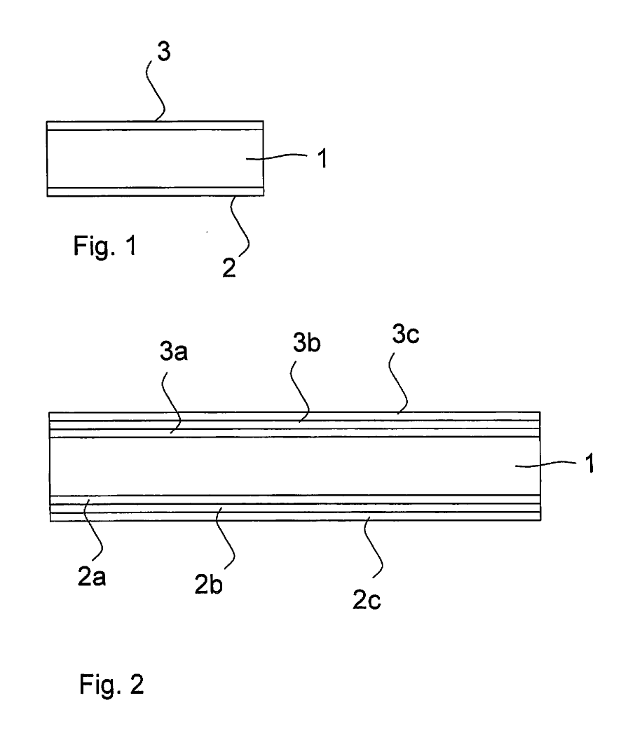

The heating element shown in FIG. 1 includes a ceramic body 1, a first electrode 2, and a second electrode 3. The electrode 2 is arranged on the lower primary surface and electrode 3 on the upper primary surface of body 1. Both body 1 and electrodes 2 and 3 are lead-free.

FIG. 2 shows a variation of the heating element shown in FIG. 1, in which each electrode includes a number of layers. The lower electrode has an inner contact layer 2a, a diffusion barrier layer 2b, and another contact layer 2c. The upper electrode correspondingly has an inner contact layer 3a, a diffusion barrier layer 3b and another contact layer 3c.

The diffusion barrier layers 2b and 3b are arranged between the contact layers 2a, 3a and 2c, and 3c. The inner contact layers 2a and 3a are arranged between the body 1 and the diffusion barrier layers 2b and 3b.

Each of the layers 2a, 2b, 2c, 3a, 3b, 3c is lead-free.

The heating element can be used in motor vehicle applications in 12/24/42 V operation, preferably for heating of vehicle interiors, especially in the case of diesel vehicles (automobiles, trucks, commercial vehicles) as well as gasoline-powered vehicles. Preferably, several identical heating elements are arranged on a common carrier, electrically connected together and thus assembled into a heating system.

The ceramic body 1 is sintered. Ceramic raw materials without lead additives are used to make the ceramic body 1. The ceramic raw material preferably contains BaTiO₃. In one variation, the ceramic raw material contains an amount of SrTiO₃ (for example, in addition to the barium titanate). Alternatively, the body 1 can be free of SrTiO₃.

The following ceramic compositions, for example, are considered to be advantageous: BaTiO₃ 50-85%, CaTiO₃ 3-15%, SrTiO₃ up to 50%, SiO₂ 1-2%.

The electrodes 2, 3 or their partial layers 2a-2c, 3a-3c are preferably produced in a metal deposition process. Examples are sputtering, evaporation, electrolytic deposition, and chemical deposition. However, the electrodes 2, 3 can also be produced by baking on a metal paste. The thickness of the electrodes 2, 3 can be between 2 μm and 25 μm, depending on the specific embodiment.

In an advantageous embodiment, the electrodes 2, 3 can contain metallic Al as a base material. The base material of the electrodes 2, 3 can be enriched with glass flux. The amount of glass flux is preferably about 5%. The thickness of an electrode 2, 3 that contains Al as a base material and a glass flux as an additive is preferably 20 μm.

Alternatively, the glass flux can be omitted, so that the electrodes 2, 3 are free of glass additives. The thickness of an Al electrode without glass flux is preferably 4 μm.

The electrodes 2 (3) can have a layer sequence that includes several partial layers 2a-2c (3a-3c). The layer sequence can, in particular, have a base layer 2a (3a) which functions as the inner contact layer, and a diffusion barrier layer 2b (3b). The inner contact layer 2a (3a) serves for ohmic contact with the ceramic body 1. Aluminum, chromium or a zinc-containing layer, for example, is suitable as the contact layer 2a (3a). A nickel layer can be applied directly to the ceramic body 1 or to the contact layer 2a (3a) which depending on the embodiment, is suitable as a diffusion barrier layer. The layer sequence preferably also includes a conductive layer (outer contact layer 2c (3c)), which has good electric conductivity that is higher than that of the underlying layers. For example, a silver layer or a silver-containing layer is suitable as the conductive layer 2c (3c). Other layer sequences, not specified here, are also possibilities for the electrodes of the heating element.

The electrodes 2, 3 produced in a bake-on process are produced with bake-on pastes that contain an amount of glass. In producing such electrodes, a metal paste with a glass additive that is lead-free is used. The metal paste also contains organic binders, which are preferably burned off completely when baking on the electrodes.

The heating element preferably has two main surfaces. In a preferred variation, the first electrode 2 is arranged on the first primary surface and the second electrode 3 is arranged on the second primary surface.

The heating element can be designed as a surface-mountable structural element. The specific resistance of the heating element can be set, for example, between about 10 and about 500 ohm·cm. However, the resistance value is not limited to this range.

What is claimed is:

1. A heating element comprising:
a ceramic body that has positive temperature coefficient properties; and
electrodes arranged on the ceramic body, wherein the ceramic body and the electrodes are lead-free.

2. The heating element of claim 1, wherein the ceramic body contains BaTiO₃.

3. The heating element of claim 1, wherein the ceramic body contains SrTiO₃.

4. The heating element of claim 1, wherein the ceramic body is free of SrTiO₃.

5. The heating element of claim 1, wherein the electrodes contain Al.

6. The heating element of claim 1, wherein the electrodes each have a layered sequence that comprises an inner contact layer, a diffusion barrier layer and an outer contact layer.

7. The heating element of claim 1, wherein the electrodes contain an amount of glass.

8. The heating element of claim 1, wherein the heating elements are free of glass additives.

9. The heating element of claim 1, wherein a first electrode is arranged on a first primary surface of the ceramic body and a second electrode is arranged on a second primary surface of the electrodes.

10. The heating element of claim 1, wherein the heating element is surface mountable.

11. A heating element comprising:
a ceramic body having positive temperature coefficient properties, the ceramic body including a first primary surface and an opposed second primary surface, the ceramic body being lead free and comprising a material selected from the group consisting of BaTiO₃ and SrTiO₃;
a first electrode disposed on the first primary surface, the first electrode being lead free; and
a second electrode disposed on the second primary surface, the second electrode being lead free.

12. The heating element of claim 11, wherein the first and second electrodes each comprise Al.

13. The heating element of claim 11, wherein the first and second electrodes each have a layer sequence that comprises an inner contact layer touching the ceramic body, a diffusion barrier layer over the inner contact layer and an outer contact layer over the diffusion barrier layer.

14. The heating element of claim 11, wherein the first and second electrodes each contain an amount of glass.

15. The heating element of claim 11, wherein the first and second electrodes are each free of any glass additives.

16. A method of making a heating element, the method comprising:
providing a ceramic body that has positive temperature coefficient properties, the contact body being lead free;
forming a first electrode over a first region of the ceramic body, the first electrode being lead free; and
forming a second electrode over a second region of the ceramic body, the second electrode being lead free.

17. The method of claim 16, wherein at least a portion of the first electrode is formed by sputtering, evaporation, electrolytic deposition, chemical deposition, or baking on.

18. The method of claim 16, wherein the ceramic body contains BaTiO₃.

19. The method of claim 16, wherein the ceramic body is free of SrTiO₃.

20. The method of claim 16, wherein the first and second electrodes each contain an amount of glass.
